(19) United States
(12) Patent Application Publication
(10) Pub. No.: US 2026/0341884 A1
(43) Pub. Date: Oct. 29, 2026

(54) MULTI-FUNCTIONAL FOAM STRUCTURES FOR TRACTION BATTERY PACKS

(71) Applicant: FORD GLOBAL TECHNOLOGIES, LLC, Dearborn, MI (US)

(72) Inventors: Daniel Paul Roberts, Livonia, MI (US); Alexey Konstantinov, Southgate, MI (US); Daryl Arnell Marlow, Dearborn, MI (US); Francisco Fernandez-Galindo, Canton, MI (US)

(21) Appl. No.: 19/189,528

(22) Filed: Apr. 25, 2025

(51) Int. Cl. H01M 50/291; B60L 50/64; H01M 10/0525; H01M 10/658; H01M 50/209; H01M 50/249; H01M 50/271; H01M 50/293

(52) U.S. Cl. CPC H01M 50/291; B60L 50/64; H01M 10/0525; H01M 10/658; H01M 50/209; H01M 50/249; H01M 50/271; H01M 50/293; H01M 2220/20

(57) ABSTRACT

Multi-functional foam structures are provided for use within traction battery packs. An exemplary foam structure may be arranged to partially surround a subgrouping of battery cells of a battery array for providing inter-cell spacing and limiting battery cell movement. In some implementations, the foam structure may include an integrated thermal barrier for additionally limiting the transfer of thermal energy across the battery array and/or between the battery array and an adjacent structure.

### TECHNICAL FIELD

This disclosure relates generally to electrified vehicle traction battery packs, and more particularly to multi-functional foam structures for placement between battery cell subgroupings of a battery array of a traction battery pack.

### BACKGROUND

A high voltage traction battery pack typically powers the electric machines and other electrical loads of an electrified vehicle. The traction battery pack includes a plurality of battery cells and various other battery internal components that support the electric propulsion of the vehicle.

### SUMMARY

A traction battery pack according to an exemplary aspect of the present disclosure includes, among other things, a battery array, and a U-shaped foam structure arranged to partially surround a first subgrouping of battery cells of the battery array.

In a further non-limiting embodiment of the foregoing traction battery pack. the first subgrouping is arranged axially between a second subgrouping of battery cells and a third subgrouping of battery cells of the battery array.

In a further non-limiting embodiment of either of the foregoing traction battery packs, the U-shaped foam structure includes a first wall section that extends axially between the first subgrouping and the second subgrouping, and a second wall section that extends axially between the first subgrouping and the third subgrouping.

In a further non-limiting embodiment of any of the foregoing traction battery packs, the U-shaped foam structure includes a third wall section that extends between the first wall section and the second wall section.

In a further non-limiting embodiment of any of the foregoing traction battery packs, the third wall section extends over top of the first subgrouping of the battery cells.

In a further non-limiting embodiment of any of the foregoing traction battery packs, the third wall section extends between the first subgrouping and an upper enclosure structure.

In a further non-limiting embodiment of any of the foregoing traction battery packs, the upper enclosure structure is a top cover of the battery array or an enclosure cover of an enclosure assembly of the traction battery pack.

In a further non-limiting embodiment of any of the foregoing traction battery packs, the first wall section, the second wall section, and the third wall section are integrated to establish a unitary, single-piece design of the U-shaped foam structure.

In a further non-limiting embodiment of any of the foregoing traction battery packs, the U-shaped foam structure is made of a polyurethane foam.

In a further non-limiting embodiment of any of the foregoing traction battery packs, the U-shaped foam structure includes an integrated thermal barrier.

In a further non-limiting embodiment of any of the foregoing traction battery packs, the integrated thermal barrier includes a first thermally insulating sheet and a second thermally insulating sheet connected by a bridge.

In a further non-limiting embodiment of any of the foregoing traction battery packs, the first thermally insulating sheet, the second thermally insulating sheet, and the bridge are each made of a mica material.

A traction battery pack according to another exemplary aspect of the present disclosure includes, among other things, a battery array, and a foam structure positioned to compartmentalize the battery array. The foam structure includes a first wall section adjacent a first battery cell of a first subgrouping of battery cells and a first battery cell of a second subgrouping of battery cells of the battery array, a second wall section adjacent a second battery cell of the first subgrouping and a first battery cell of a third subgrouping of battery cells of the battery array, and a third wall section that connects between the first wall section and the second wall section.

In a further non-limiting embodiment of the foregoing traction battery pack, the foam structure is a U-shaped foam structure that surrounds three sides of the first subgrouping.

In a further non-limiting embodiment of either of the foregoing traction battery packs, the foam structure is made of a polyurethane foam.

In a further non-limiting embodiment of any of the foregoing traction battery packs, the third wall section extends over top of the first subgrouping.

In a further non-limiting embodiment of any of the foregoing traction battery packs, the third wall section extends between the first subgrouping and an upper enclosure structure.

In a further non-limiting embodiment of any of the foregoing traction battery packs, the foam structure includes a thermal barrier.

In a further non-limiting embodiment of any of the foregoing traction battery packs, the thermal barrier includes a thermally insulating sheet.

In a further non-limiting embodiment of any of the foregoing traction battery packs, the thermally insulating sheet includes a mica material.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a cross-sectional view of select portions of a battery array of a traction battery pack. A foam structure is arranged between adjacent subgroupings of battery cells of the battery array.

FIG. 3 is a blown-up view of a portion of the battery array of FIG. 2.

FIGS. 4 and 5 illustrate an exemplary foam structure of a battery array.

### DETAILED DESCRIPTION

This disclosure details multi-functional foam structures for use within traction battery packs. An exemplary foam structure may be arranged to partially surround a subgrouping of battery cells of a battery array for providing inter-cell spacing and limiting battery cell movement. In some implementations, the foam structure may include an integrated thermal barrier for additionally limiting the transfer of thermal energy across the battery array and/or between the battery array and an adjacent structure. These and other features are discussed in greater detail in the following paragraphs of this detailed description.

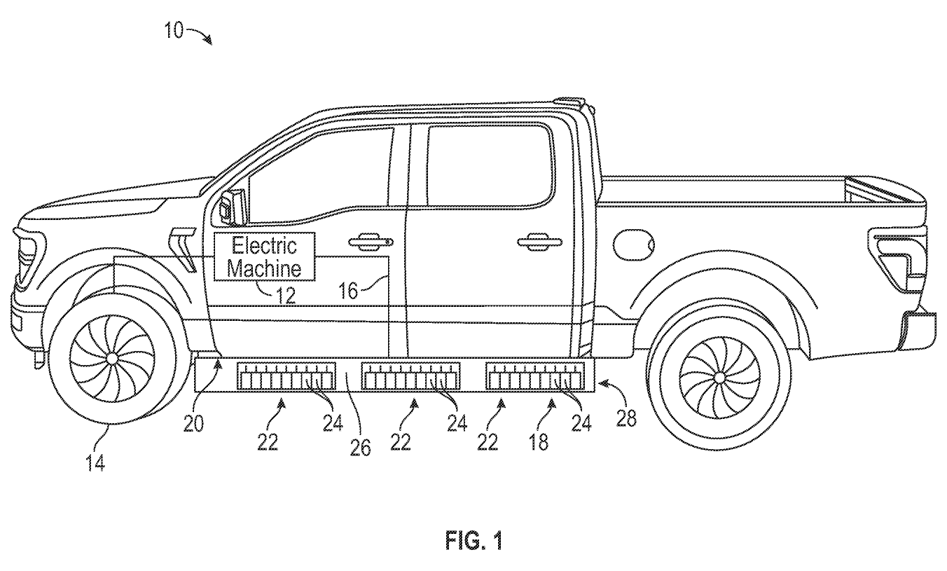

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV’s), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

As schematically shown, the traction battery pack 18 may include one or more battery arrays 22 (e.g., battery modules or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The one or more battery arrays 22 of the traction battery pack 18 may each include a plurality of battery cells 24 that store energy for powering various electrical loads of the electrified vehicle 10. The traction battery pack 18 could employ any number of battery cells 24 within the scope of this disclosure. Accordingly, this disclosure should not be limited to the highly schematic configuration shown in FIG. 1.

In an embodiment, the battery cells 24 of each battery array 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28 of the traction battery pack 18. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

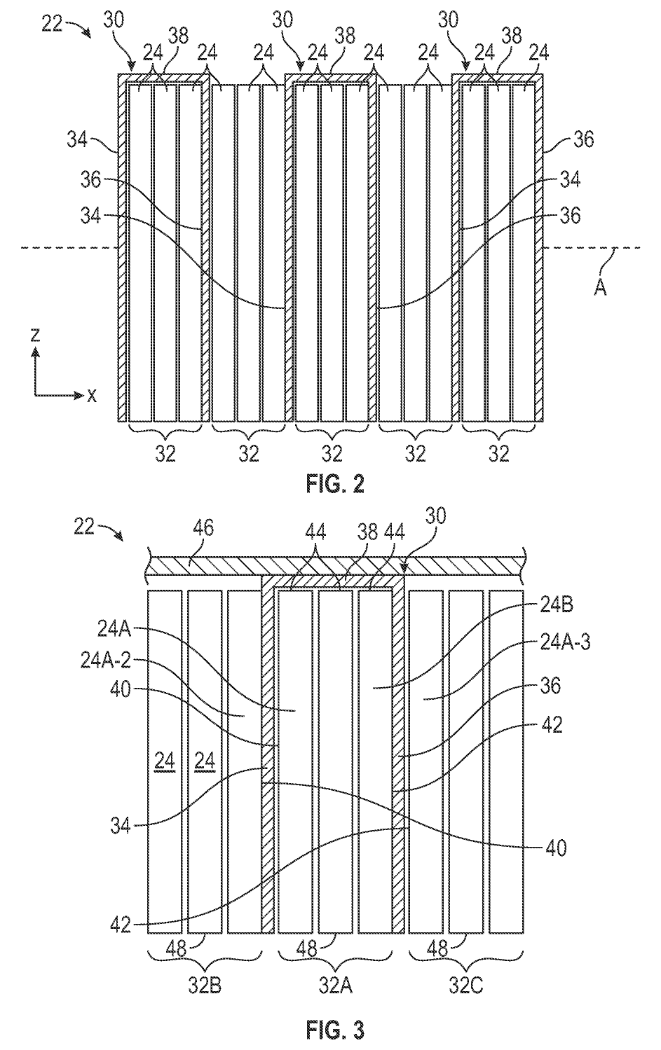

FIG. 2 illustrates select portions of one of the battery arrays 22 of the traction battery pack 18 of FIG. 1. The battery array 22 may include a plurality of battery cells 24. The total number of battery cells 24 provided within the battery array 22 could vary and is not intended to limit this disclosure. The battery cells 24 may be arranged together along a stack axis A. The stack axis A may extend along a longitudinal or X-axis of the traction battery pack 18.

The battery array 22 may further include one or more foam structures 30 that can be arranged along the stack axis A. Each foam structure 30 may be configured to provide both inter-cell spacing and top compression for limiting vertical or Z-axis movement of the battery cells 24 with a single component.

The foam structures 30 may compartmentalize the battery array 22 into two or more subgroupings 32 of the battery cells 24. In the illustrated embodiment, the battery array 22 includes a total of five subgroupings 32 of the battery cells 24. However, other configurations are contemplated within the scope of this disclosure.

Each subgrouping 32 of the battery array 22 may include one or more of the battery cells 24. In an embodiment, each subgrouping 32 includes a total of three battery cells 24. However, other configurations are contemplated within the scope of this disclosure.

Each foam structure 30 may be arranged to partially surround one of the subgroupings 32 of the battery array 22. In an embodiment, one foam structure 30 is provided to partially surround every other subgrouping 32 of the battery array 22. However, other configurations are contemplated within the scope of this disclosure.

Each foam structure 30 may be configured as a U-shaped foam structure that includes a first wall section 34, a second wall section 36, and a third wall section 38 that connects between the first wall section 34 and the second wall section 36. The first wall section 34, the second wall section 36, and the third wall section 38 may be formed together to provide a unitary, single-piece structural design of each foam structure 30.

The foam structures 30 may be made of a polyurethane foam. However, other materials or combinations of materials could be utilized to construct the foam structures 30 within the scope of this disclosure.

FIG. 3 illustrates further details with specific reference to one of the foam structures 30 of the battery array 22. In this implementation, the foam structure 30 is arranged to partially surround a first subgrouping 32A of the battery cells 24 of the battery array 22. The first subgrouping 32A is positioned axially between a second subgrouping 32B and a third subgrouping 32C of the battery cells 24 of the battery array.

The first wall section 34 of the foam structure 30 may extend vertically between a first battery cell 24A of the first subgrouping 32A and a first battery cell 24A-2 of the second subgrouping 32B. The first wall section 34 may extend in abutting contact with a major side surface 40 of each of the first battery cell 24A of the first subgrouping 32A and the first battery cell 24A-2 of the second subgrouping 32B. The first wall section 34 may therefore be positioned to provide inter-cell spacing between the battery cells of the first subgrouping 32A and the second subgrouping 32B. The first wall section 34 may further accommodate battery cell compression and expansion forces.

The second wall section 36 of the foam structure 30 may extend vertically between a second battery cell 24B of the first subgrouping 32A and a first battery cell 24A-3 of the third subgrouping 32C. The second wall section 36 may extend in abutting contact with a major side surface 42 of each of the second battery cell 24B of the first subgrouping 32A and the first battery cell 24A-3 of the third subgrouping 32C. The second wall section 36 may therefore be positioned to provide inter-cell spacing between the battery cells of the first subgrouping 32A and the third subgrouping 32C. The second wall section 36 may further accommodate battery cell compression and expansion forces.

The third wall section 38 of the foam structure 30 may extend horizontally between the first wall section 34 and the second wall section 36. The third wall section 38 may extend in abutting contact with a top surface 44 of each battery cell 24 of the first subgrouping 32A. The third wall section 38 may therefore be positioned to provide a compressive force to the first subgrouping 32A for limiting vertical or Z-axis movement of the battery cells 24 included within the first subgrouping 32A.

In some implementations, the third wall section 38 of the foam structure 30 may extend between the top surfaces 44 of the battery cells 24 and an upper enclosure structure 46. The upper enclosure structure 46 could be a top cover of the battery array 22 or the cover of the enclosure assembly 28, for example.

By virtue of its U-shaped design, the foam structure 30 may surround three sides of the first subgrouping 32A of the battery array 22. Notably, bottom surfaces 48 of the battery cells of the first subgrouping 32A are not surrounded or covered by the foam structure 30.

For the purposes of this disclosure, vertical and horizontal are with reference to ground and a general orientation of traction battery pack 18 when installed on the electrified vehicle 10 of FIG. 1.

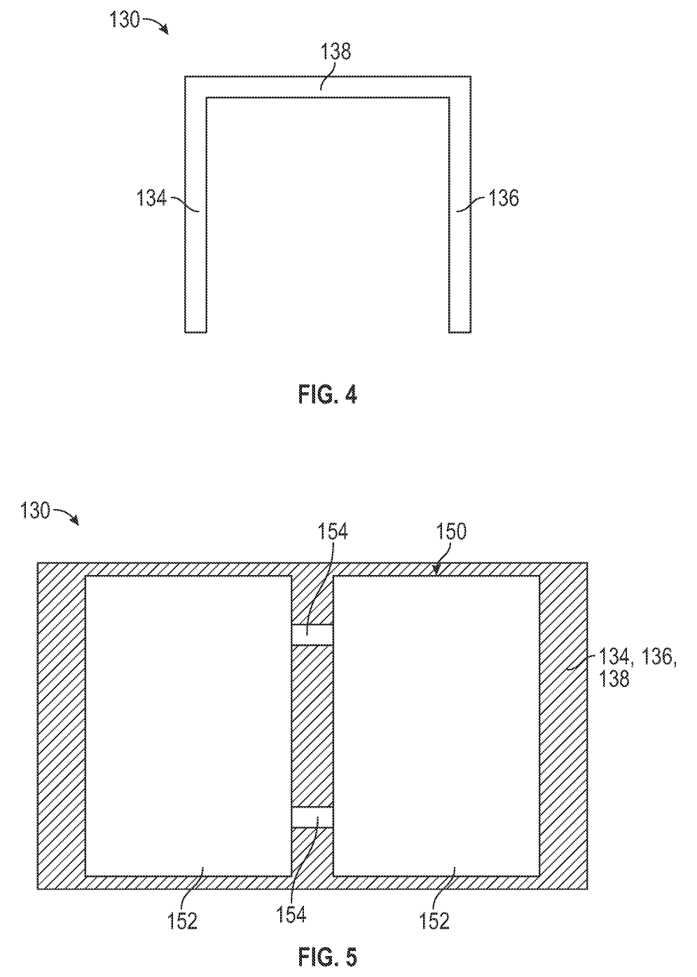

FIGS. 4-5 illustrate another exemplary foam structure 130 for a battery array of a traction battery pack. The foam structure 130 may is similar to the foam structure 30 discussed above and therefore may include a U-shaped design that includes a first side wall 134, a second side wall 136, and a third side wall 138. However, in this implementation, the foam structure 130 may additionally include a thermal barrier 150 that is configured to limit the transfer of thermal energy across the battery array 22 and/or between the battery array and adjacent structures.

The thermal barrier 150 may be imbedded or otherwise integrated into one or more of the first side wall 134, the second side wall 136, and the third side wall 138 for managing the transfer of thermal energy, such as when one of the battery cells 24 of the battery array releases vent gases during a thermal event, for example.

Each thermal barrier 150 may include one or more thermally insulating sheets 152 that can be connected by bridges 154. The thermally insulating sheets 152 and the bridges 154 may be made of thermally resistant materials such as mica, aerogels, silicas, etc.

The exemplary foam structures of this disclosure provide an integrated design that accomplishes multiple design functions in fewer parts compared to existing designs that utilize separate and multi-sized spacers both between and above battery cell groupings. The foam structures provide a novel configuration for providing inter-cell spacing, top compression, slowing or even preventing the transfer of thermal energy, increasing space utilization and packaging efficiency, reducing noise, vibration, and harshness, simplifying installation and packaging, augmenting cell venting performance, etc.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery array; and
a U-shaped foam structure arranged to partially surround a first subgrouping of battery cells of the battery array.

2. The traction battery pack as recited in claim 1, wherein the first subgrouping is arranged axially between a second subgrouping of battery cells and a third subgrouping of battery cells of the battery array.

3. The traction battery pack as recited in claim 2, wherein the U-shaped foam structure includes a first wall section that extends axially between the first subgrouping and the second subgrouping, and a second wall section that extends axially between the first subgrouping and the third subgrouping.

4. The traction battery pack as recited in claim 3, wherein the U-shaped foam structure includes a third wall section that extends between the first wall section and the second wall section.

5. The traction battery pack as recited in claim 4, wherein the third wall section extends over top of the first subgrouping of the battery cells.

6. The traction battery pack as recited in claim 5, wherein the third wall section extends between the first subgrouping and an upper enclosure structure.

7. The traction battery pack as recited in claim 6, wherein the upper enclosure structure is a top cover of the battery array or an enclosure cover of an enclosure assembly of the traction battery pack.

8. The traction battery pack as recited in claim 4, wherein the first wall section, the second wall section, and the third wall section are integrated to establish a unitary, single-piece design of the U-shaped foam structure.

9. The traction battery pack as recited in claim 1, wherein the U-shaped foam structure is comprised of a polyurethane foam.

10. The traction battery pack as recited in claim 1, wherein the U-shaped foam structure includes an integrated thermal barrier.

11. The traction battery pack as recited in claim 10, wherein the integrated thermal barrier includes a first thermally insulating sheet and a second thermally insulating sheet connected by a bridge.

12. The traction battery pack as recited in claim 11, wherein the first thermally insulating sheet, the second thermally insulating sheet, and the bridge are each comprised of a mica material.

13. A traction battery pack, comprising:
a battery array; and
a foam structure positioned to compartmentalize the battery array, wherein the foam structure includes a first wall section adjacent a first battery cell of a first subgrouping of battery cells and a first battery cell of a second subgrouping of battery cells of the battery array, a second wall section adjacent a second battery cell of the first subgrouping and a first battery cell of a third subgrouping of battery cells of the battery array, and a third wall section that connects between the first wall section and the second wall section.

14. The traction battery pack as recited in claim 13, wherein the foam structure is a U-shaped foam structure that surrounds three sides of the first subgrouping.

15. The traction battery pack as recited in claim 13, wherein the foam structure is comprised of a polyurethane foam.

16. The traction battery pack as recited in claim 13, wherein the third wall section extends over top of the first subgrouping.

17. The traction battery pack as recited in claim 16, wherein the third wall section extends between the first subgrouping and an upper enclosure structure.

18. The traction battery pack as recited in claim 13, wherein the foam structure includes a thermal barrier.

19. The traction battery pack as recited in claim 18, wherein the thermal barrier includes a thermally insulating sheet.

20. The traction battery pack as recited in claim 19, wherein the thermally insulating sheet is comprised of a mica material.
